(19) United States
(12) Patent Application Publication
(10) Pub. No.: US 2006/0217112 A1
(43) Pub. Date: Sep. 28, 2006

(54) System And Method For A Virtual Mobile Network

(76) Inventor: Richard Mo, Colorado Springs, CO (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/277,336

(22) Filed: Mar. 23, 2006

Related U.S. Application Data
(60) Provisional application No. 60/664,337, filed on Mar. 23, 2005.

(51) Int. Cl. H04Q 7/20

(52) U.S. Cl. 455/422.1

(57) ABSTRACT

A system, various methods, and various apparatuses are provided whereby a virtual mobile network can be created, in which multiple disparate networks can be interconnected to form a unified network environment. In this virtual mobile network environment a user can roam and handover an active call seamlessly between any two interconnected networks. For example, between: a) two private networks, b) a private network and a public cellular network and c) a private network and a public carrier network. The system also enables a user to access enterprise communications services in one network from any networks within this virtual Mobile network environment seamlessly.

The present application claims the benefit of and priority to U.S. Provisional Patent Application No. 60/664,337 entitled “System and Method for a Virtual Mobile Network Supporting Seamless Roaming and handover Between any two Heterogeneous Networks and for Accessing Communications Services in one Network from Another Network” and filed on Mar. 23, 2005, and is hereby, incorporated by reference.

### TECHNICAL FIELD

The field of the invention generally relates to converged wired and wireless networks and more particularly relates to a method and system for a virtual mobile network.

### BACKGROUND

In cellular networks, roaming allows a cellular customer to automatically make and receive voice calls, send and receive data, or access other services when traveling outside the geographical coverage area of the home network, by means of using a visited network. With the Internet roaming refers to accessing the Internet when away from home at the price of a local call or at a charge considerably less than the regular long-distance charges. With WiFi networking roaming refers to the ability to move from one access point (AP) coverage area to another without interruption in service or loss in connectivity. Roaming is generally restricted to within the same network type. However, roaming between heterogeneous networks is not addressed. Roaming between fixed carrier networks, cellular networks, and private networks is not defined.

handover, (or handoff), is the process by which a Mobile Telephone Switching Office passes a cellular phone conversation from one radio frequency in one cell to another radio frequency in another a cell. It is performed so quickly that callers do not notice. Handover, unlike roaming involves moving an active call from one radio to another radio. From a user's perspective, the need to handover an active call does not limit to between networks of same network type. A handover function is needed to handover an active call from one network type to another network type, and from one device to another device, for example, from a wireless private network to cellular public network, from a wired desktop phone to a cellular phone.

Some systems attempt to emulate roaming and handover calls between enterprise and cellular networks. The most common technique involves ringing the user's enterprise phone and cellular phone either simultaneously or sequentially to attempt reaching the user. One such system is outlined in U.S. Pat. No. 5,668,862. Others include the Power connect system by Ascendent. Since these systems do not actually know where the user is, the attempt to simultaneously ring all the phones which can potentially reach the user creates multiple calls in the network, consuming un-necessary network resources. It also causes multiple phones to ring and potentially confuses the user. The technique to sequentially ring all the potential phones introduces delays in call delivery and may cause the calling party to give up and abandon the call before the called party has a chance to answer it.

In addition, simultaneous and sequential ringing techniques create more calls to the called user than necessary and may interfere with other call features such as call waiting. Since call waiting is usually limited by the number of calls that can be queued to wait for the called party, some calls may be sent to voice mail or busy treatment un-necessarily.

Moreover, the techniques employed by prior systems to emulate the handover function usually are intrusive and require the user to manually initiate and complete the transfer of the call and inevitably disruptive the connection between the parties. This is less than desirable.

Other systems that focus on data connections employ techniques such as mobile IP to emulate the handover function. In these systems, the call is anchored in the network using mobile IP and when the user roams out of range of the current access radio and loses the connection, the call is kept alive in the network, waiting for the user to reconnect from a new radio access point. This technique and techniques like it incur prolonged delays and latency that is undesirable and unacceptable for real time sensitive applications such as telephony and video streaming. Re-authentication from the new radio access is generally required when handover and roaming occurs across networks or across radio subnets. These re-authentications while necessary also introduce unacceptable delays.

Efforts are ongoing in the networking standards community and industry consortia to create mechanisms whereby users can roam between WiFi radio access points and cellular radios. The Unlicensed Mobile Access (UMA) standard developed by the Unlicensed Mobile Access Technology consortium is standardizing how to interconnect WiFi enabled mobile stations to a GSM cellular network via WiFi access points. However, the UMA architecture only extends the GSM cellular network architecture to include a specialized IP Base Station Controller (BSC) (named Unlicensed Network Controller (UNC)) to support IP connections to interface with UMA-compliant mobile stations via WiFi or Bluetooth access points. There is no provision to allow integration of private enterprise network services. For example, handing over calls from the private enterprise communications system to cellular network is not supported. Other efforts such as the Inter Access point Protocol (IAPP) standard from Internet Engineering Task Force (IETF) define the mechanisms used to facilitate fast handover between WiFi access points within a radio subnet, but does not address inter radio subnet handover situations.

### SUMMARY OF THE INVENTION

A method and system for a virtual mobile network are disclosed. In one embodiment, the system comprises one or more networks with a plurality of mobile stations and mobility orchestration servers. Mobile station comprising a personal mobility assistant, a mobile station management, and a wireless client component. Mobility orchestration server comprising a service manager, a network gateway, and an information security component.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The invention will be better understood from a reading of the following detailed description in conjunction with the drawing figures, in which like reference designators are used to identify like elements and in which:

FIG. 1 illustrates a high-level block diagram of an exemplary virtual mobile network, according to one embodiment of the present invention;

FIG. 2 illustrates a block diagram of an exemplary mobile station, according to one embodiment of the present invention;

FIG. 3 illustrates a block diagram of an exemplary mobility orchestration server according to one embodiment of the present invention;

FIG. 3a illustrates location areas and handover boundaries according to one embodiment of the present invention;

FIG. 4 illustrates a signaling sequence chart and flow chart for an exemplary roaming process, according to one embodiment of the present invention;

FIG. 5 illustrates a signaling sequence chart and flow chart for an exemplary outgoing call process according to one embodiment of the present invention;

FIG. 6 illustrates a signaling sequence chart and flow chart for an exemplary incoming call process according to one embodiment of the present invention;

FIGS. 7a and 7b illustrate signaling sequence charts and flow charts for an exemplary handover to a cellular network and a handover between subnets processes, according to one embodiment of the present invention;

FIG. 7c illustrates a signaling sequence chart and flow chart for an exemplary Three way conference service on a user's home circuit switch system according to one embodiment of the present invention;

FIG. 8 illustrates a signaling sequence chart and flow chart for an exemplary event notification process according to one embodiment of the present invention; and

FIG. 9 illustrates a signaling sequence chart and flow chart for an exemplary remote dialing process, according to one embodiment of the present invention;

### DETAILED DESCRIPTION

This invention pertains in general to electronic communication in circuit switched networks such as those using Time Divisional Multiplex (TDM) voice technologies, and in packet multimedia networks, such as those using Voice over Internet Protocol (VoIP) technologies. The present method and system pertains in particular to providing a mechanism whereby a virtual mobile network can be created, in which multiple disparate and heterogeneous networks can be interconnected to form a unified network environment. In this virtual mobile network environment a user can roam and handover an active call seamlessly between any two interconnected heterogeneous networks. For example, between: a) two private networks, b) a private network and a public cellular network and c) a private network and a public carrier network. The present method and system further pertains in particular to a mechanism whereby a user can access enterprise communications services in one network from any networks within this Virtual Mobile Network environment seamlessly.

One embodiment of the present system enhances existing switching network systems such as Key Systems, Private Branch Exchanges, Public Switched Telephone Network switch systems, and cellular network switch systems, to facilitate users roaming between these networks, such as from a TDM based private branch exchange network to an all IP based private branch exchange network or from an all IP based private branch exchange network to a circuit switched 2G public cellular switched network. Users roam from their own private enterprise networks to other private enterprise networks and continue to get access to their own familiar private enterprise communications systems services. They roam between their enterprise communications systems to cellular networks without disruption to their enterprise communications system services. Users also carry active calls from one network to another network or from one subnet to another subnet without negatively affecting or dropping the call. For example, they carry a call from their enterprise communications systems using WiFi access technology optimal for the enterprise environment to the cellular network without dropping the call.

A set of systems and methods is described in which a Virtual Mobile Network is created and in which multiple disparate networks are interconnected to form a unified network environment for the users. In this virtual mobile network environment, a user may roam and handover an active call seamlessly, without user perceptible delays, between any two interconnected networks or subnets. For example, between: a) two private networks, b) a private network and a public cellular network, c) a private network and a public carrier network and d) between two radio subnets of a private network.

The concept of presence, knowing whether a user is inactive, busy on a call, or does not want to be disturbed before attempting to connect to the user, has been explored with private enterprise communications systems, such as the Nortel Multimedia Communications Server and the Orative Enterprise Software. However, the scope of these systems are either limited to presence information of users from a single location or a single enterprise. Presence information across enterprise boundaries is typically not available in prior art systems.

Many useful enterprise productivity services (such as enterprise directory, work group calendar co-ordination system, enterprise Instant Messaging service, enterprise voice message waiting indicator) are only available when the user is at his or her business office. As the user roams away from the office, these services are not available, and thus the user's productivity is limited while working away from the business office.

The present system helps roaming users access familiar and useful productivity services of their enterprise communications systems while roaming to other networks. When the user is away from the office visiting a branch office, visiting a customer's office, or in transit, the desk top productivity service environment is extended to the roaming user's mobile handset. The user, for example, may find out the presence information of the user's co-worker, book appointments with co-workers, and access an enterprise directory using the user's mobile handset. Furthermore, the present system facilitates the sharing of communication information, such as presence, directory and group calendar information across trusted enterprises.

A system that interfaces to existing enterprise communications systems productivity services (such as enterprise directory system, calendar services, and user presence service), to enable the sharing of enterprise communications systems information across trusted enterprises securely and to enable roaming users to access their familiar enterprise communications system's productivity services when inside or away from their business offices.

Accordingly, the present method and system describes a simple, universal way to interconnect disparate networks, regardless of whether the networks are public switch networks or private enterprise networks, whether the networks are circuit switched networks or IP-based networks. A service such as tele-service and directory service may be implemented on one network and be available to users from the other connected networks.

Simplified home location register (HLR), authentication center (AUC), and visited location register (VLR) known only to cellular networks today can be added to non-cellular networks to introduce roaming and handover capabilities to the network, whether the interconnected networks do or do not have the roaming and handover capabilities built in to their network elements. Users can roam and handover an active call between any two of the interconnected networks. In addition, the user location and presence information of one network can be shared with the other interconnected networks to effect a much larger virtual mobile network.

Further more, a user can access and interact with the user's home network's teleservice while connected via a different network. For example, a user can invoke three-way conference service on the user's enterprise PBX while connected to a cellular network.

The above and other features of the present invention are carried out in one form by a system of cooperating elements, each of which applies algorithms and other procedural means as specified below to ensure the interconnected networks function as a unified and seamless virtual mobile network to service the user.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of mobile networks and computer systems. These mobile network descriptions and representations are the means used by those skilled in the wireless networking arts to most effectively convey the substance of their work to others skilled in the art. A mobile network is here, and generally, conceived to be a system for communications among two or more computers using radio waves as its carrier. Usually, though not necessarily, the information communicated between computer systems takes the form of packets. Furthermore, for reasons of common usage, the components of the packets are referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “router” or “radio” or “frequency” or “channel” or “backbone” or “packet” or “communicate” or the like, refer to the components, and actions and processes of a network, or similar communication system, that transfers data represented as physical (electronic) quantities within the computer system's registers and memories or other such information storage, transmission or display device from one computer system to another.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories, random access memories, EPROMs, EEPROMs, magnetic or optical cards, or any type of media suitable for storing electronic instructions, and each coupled to a computer system bus.

The methods presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

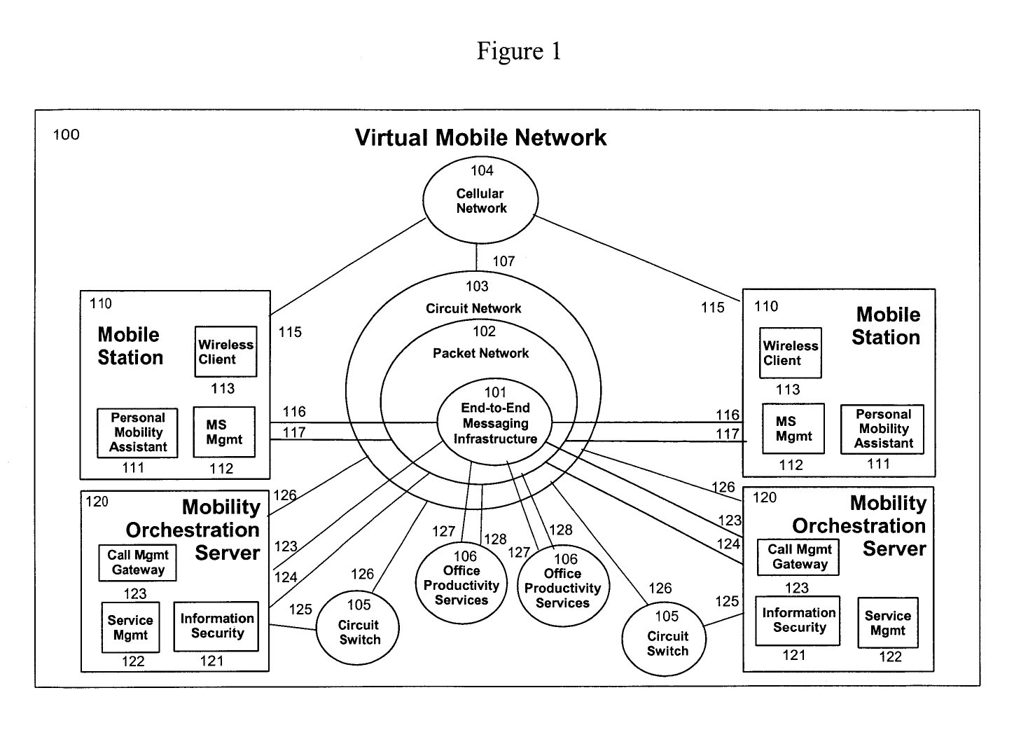

FIG. 1 illustrates a high-level block diagram of an exemplary virtual mobile network, according to one embodiment of the present invention. Virtual mobile network system 100 includes, end-to-end messaging infrastructure 101 that is the messaging backbone with which elements of the Virtual Mobile Network communicate. This Infrastructure may be any messaging system that allows users or automatic programs to exchange messages with one another. It is, in one embodiment, the Internet-standard HyperText Transfer Protocol (Secure) (HTTPS) service, but may also be implemented as an instant messaging service, a wireless short message service (SMS), Internet-standard email service, any other messaging service, or any combination of these. Packet network 102 forms the foundation for all communication among elements, including end-to-end Messaging Infrastructure 101 and the messages exchanged thereon, but also supports other non-messaging interactions such as web browsing. Packet network 102, in one embodiment is an Internet-based network, and may be the Internet itself, another network like it, or a composite of networks using multiple networking technologies. Circuit network 103 represents the network infrastructure with which circuit-based applications communicate. This element may be the Public Switched Telephone Network itself, or it may be a circuit switched cellular network, and/or it may be a circuit switched private enterprise network. End-to-end messaging infrastructure 101 may also send messages using circuit network 103. Cellular network 104 is a special instance of circuit network 103, and is highlighted to outline the special interface 115 to mobile station 110.

Connected to end-to-end messaging infrastructure 101 and packet network 102 is one or more mobility orchestration server 120. Each mobility orchestration server comprises a call management gateway 123, an information security module 121, a service manager 122, an interface 126 to circuit network 103, and an interface 125 to circuit switch 105. Mobility orchestration server 120, orchestrates services and capabilities provided by circuit switch 105, office productivity service 106, cellular network 104, circuit network 103, packet network 102, end-to-end messaging infrastructure 101, and mobile station 110 to create a virtual mobile network environment for users.

Also connected to end-to-end messaging infrastructure 101 and packet network 102 are one or more mobile stations 110, which are computer software applications and devices which enable mobile communication. Each mobile station includes wireless client 113 and mobile station management 112. It may also contain a personal mobility assistant 111, and an interface 115 to the cellular network 104. Wireless client 113 interfaces with other wireless interfaces, such as wireless local area networks radios, infra-red devices, special mobile radios, and cellular radios. Mobile station management 112 controls and maintains various mobile station resources such as display, microphone, speaker, memory storage, software operating system resources. In one embodiment, a mobile station 110 contains a personal mobility assistant 111 and a wireless client 113 which supports both cellular and WiFi interfaces.

In addition, connected to end-to-end messaging infrastructure 101 and packet network 102 is one or more office productivity services 106. office productivity service 106 provides office services such as enterprise directory, calendar, collaborative computing services, and customer relation management services. office productivity service 106 may also be an IP-based Key System service, IP-based Private Branch eXchange (IPBX) service, or a Public Carrier hosted or Public Carrier managed IP-based Centrex service.

Connected to circuit network 103 and mobility orchestration server 120 is one or more circuit switches 105. Circuit switch 105 may be a traditional circuit-based Key System or TDM-based PBX. It may also be a traditional circuit-based Centrex service hosted or managed by a Public Carrier.

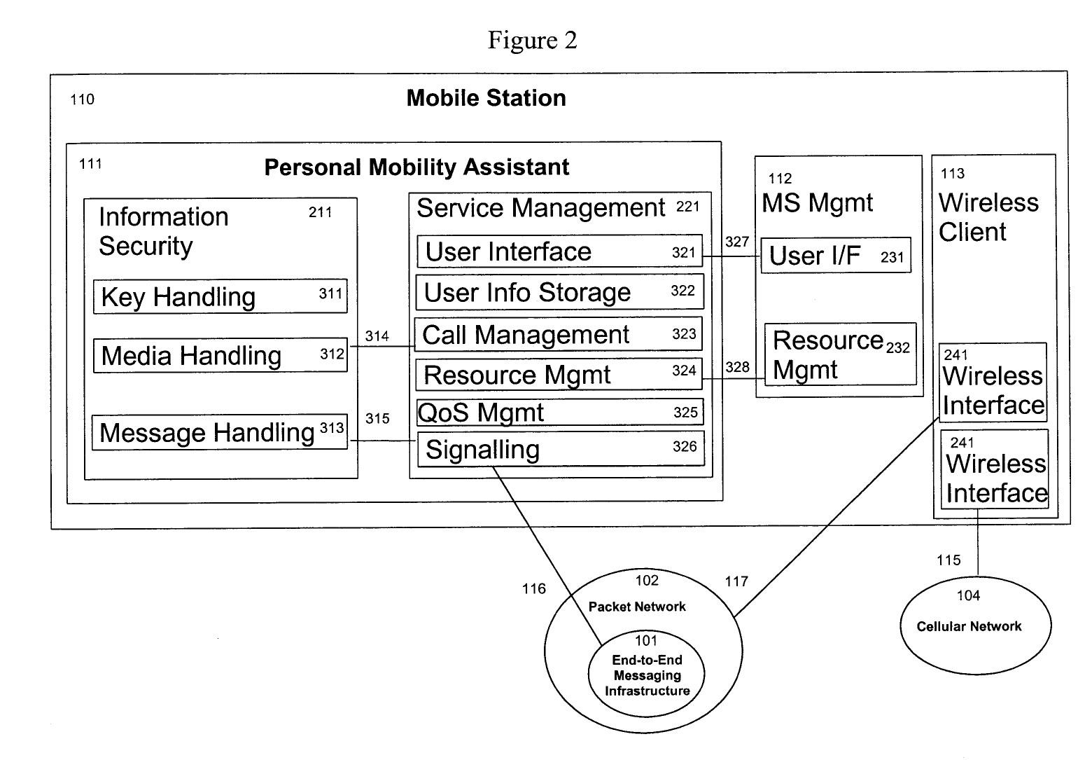

FIG. 2 illustrates a block diagram of an exemplary mobile station, according to one embodiment of the present invention. Mobile station 110 includes a wireless client 113, a mobile station management module 112, and a personal mobility assistant 111. Wireless client 113 contains at least one or more wireless interfaces 241. Wireless interface 241 can be a Cellular interface such as GSM, GPRS, EDGE, WCDMA, CDMAone, CDMA2000, or any other digital and analogue cellular radio interface. It can also be a Wireless LAN interface such as 802.11a, 802.11b, 802.11g, 802.11n, and any other Wireless LAN interfaces. wireless interface 241 can be a WiMAX interface such as 802.16, and 802.20. It can also be any other wireless interfaces such as Blue Tooth, ZigBee, and Infrared. Mobile station management 112 comprises a user interface module 231 and a Resource management module 232. User interface 231 receives commands from and presents results to the user making use of mobile station resources (such as display, microphone, and speaker) via Resource management module 232.

Personal mobility assistant 111 includes information security 211 and Service management 221. Information security 211 includes key handling 311, media handling 312, and message handling 313. Each mobile station 110 is configured with a mobility orchestration server 120, known as the mobile station's home mobility orchestration server. Key handling 311, according to one embodiment uses RSA public-key encryption and signature techniques, to perform mutual authentication with its home mobility orchestration server. It stores the public key Certificate assigned to it by the home mobility orchestration server securely. Media handling 312, encrypts the media streams of each call. Message handling 313 employs standard security and encryption techniques to ensure that communication with mobility orchestration servers 120 is secure. Service management 221 also includes user interface 321, User information storage 322, Call management 323, Resource management 324, Quality of Service management 325, and signaling module 326.

User interface 321 receives commands from mobility orchestration server and relays them to the mobile station management 112 via Interface 327. It relays user response from mobile station management 112 via Interface 327 to mobility orchestration server. User information storage 322 stores all user specific information such as user preferences, mobile station 110 capabilities, and call log information required by personal mobility assistant's 110 operation. Call management 323 maintains states of active calls and coordinates call and feature interaction activities with mobility orchestration server 120. It also gains access to mobile station 110 resources via Resource management 324. Resource management 324 makes mobile station resources available to other components of personal mobility assistant 111 via Interface 328 to mobile station management 112. Quality of Service management 325, monitors and maintains optimal quality of the connections. Quality of Service management 325 collects information on jitter, delay, Mean Opinion Score, and radio signal strengths on connections. Also in conjunction with Quality of Service management 227 of mobility orchestration server 120, Quality of Service management 325 decides when the quality of an active connection is unacceptable and triggers a handover. Signaling module 326 provides protocol support for interacting with end-to-end Messaging Infrastructure 101 via interface 116. According to one embodiment based upon HTTPS for example, the Internet-standard HyperText Transfer Protocol (Secure) is used.

According to one embodiment of a mobile station 110 is a WiFi and cellular dual mode smart phone. However, a mobile station 110 can also be a Personal Computer (PC), a Personal Digital Assistant (PDA), a single mode WiFi phone, a single mode cellular phone, a Blue Tooth device, a Zigbee device, an Infrared device, and an Unlicensed Mobile Access (UMA) compliant WiFi and cellular dual mode phone or a combination of the above-mentioned devices.

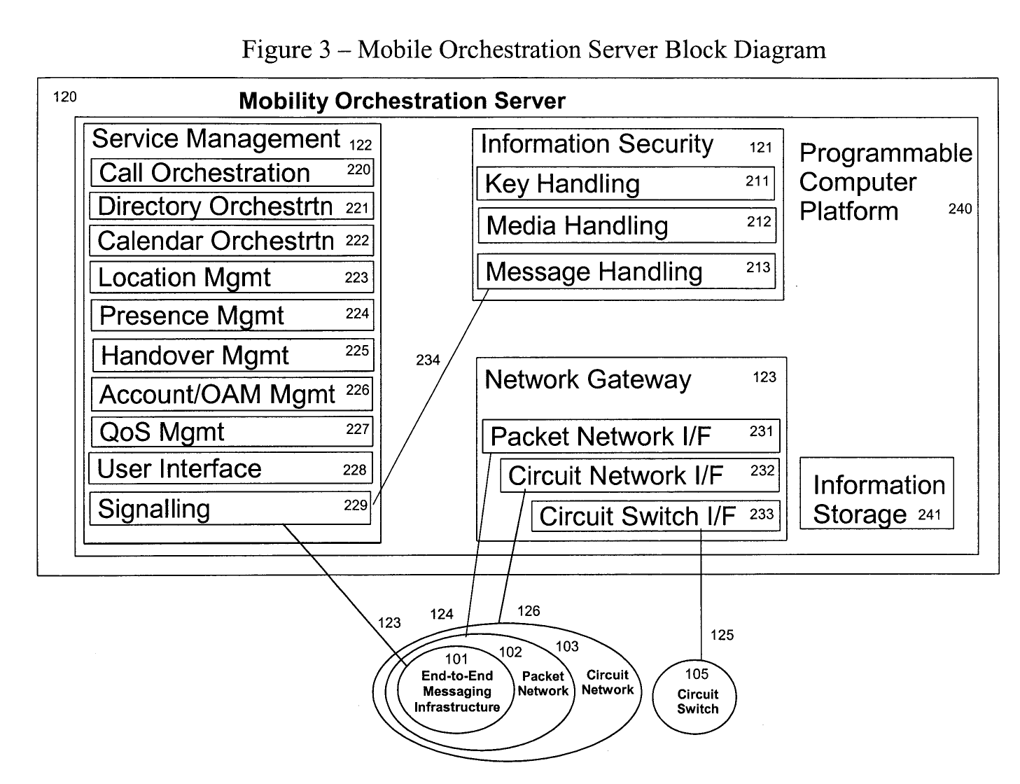

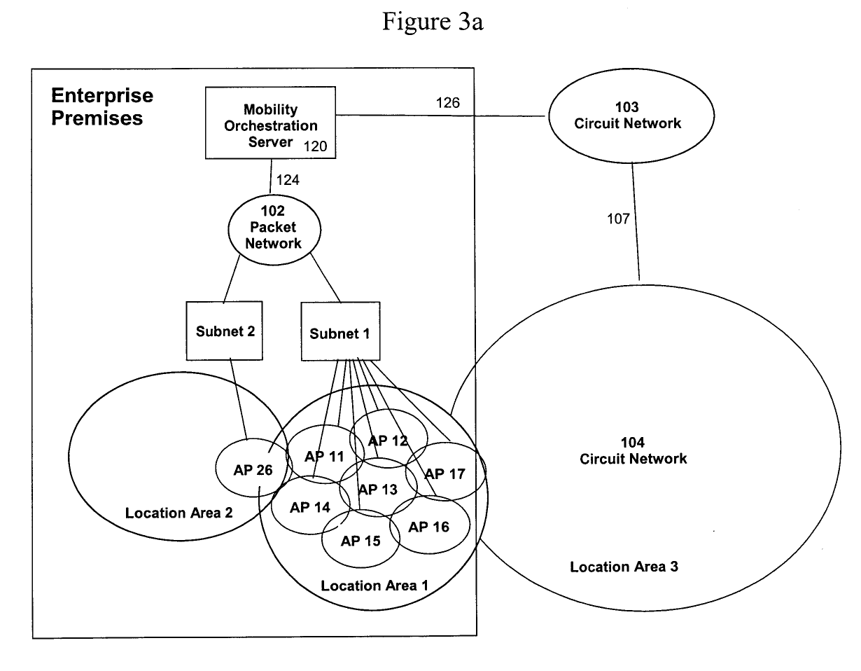

FIG. 3 illustrates a block diagram of an exemplary mobility orchestration server according to one embodiment of the present invention. Mobility orchestration server 120 includes information security 121, service management 122, network gateway 123, and information storage 241 implemented on a programmable computer platform 240. information security 121 further comprises key handling 211, Media handling 212, and message handling 213. Key handling 211, uses RSA public-key encryption and signature techniques, to perform mutual authentication with personal mobility assistants 111 requesting services. It generates, stores, and distributes public key Certificates assigned to each personal mobility assistant 111. It is also responsible for re-certification and un-certification of mobile stations. Media handling 212 uses encryption techniques to encrypt media streams of each secure call. Message handling 213 employs security and encryption techniques to ensure that communication with personal mobility assistant 111 is secure.

Network gateway 123 further comprises Packet network gateway 231, packet network Interface 231, circuit network Interface 232, and circuit switch interface 233. Packet network Interface 231 uses standard packet network protocol interfaces 124 such as TCP/IP over Ethernet to connect to packet network 102. Circuit network Interface 232, connects to circuit network 103 with circuit network interfaces 126 such as T1, E1, ISDN PRI, ISDN BRI, FXO, and many other analogue and digital circuit network interfaces. Circuit switch interface 233, connects to circuit switch 105 using Computer Telephony Interfaces (CTI) 125 such as TAPI and CSTA. CTI interfaces that are manufacturer specific such as the Meridian Link from Nortel and CorNet interface from Siemens and other PBX manufacturers CTI interfaces can also be used. There are numerous add-on computer processing cards, which implement the above described network interfaces. According to one embodiment of network gateway 123, add-on computer processing cards on Programmable Computer Platform 240 are used.

Service Manager 122 includes call orchestration 220, directory orchestration 221, calendar orchestration 222, location management 223, Presence management 224, handover management 225, Account and OAM management 226, QoS management 227, user interface 228, and Signaling module 229.

In one embodiment, call orchestration 220 coordinates calls from Internet packet network 102, Cellular circuit network 103 and Enterprise PBX circuit switch 105. It also decides which of the network gateway 123 interfaces should be used when processing call handovers and outgoing calls. Directory orchestration 221, takes directory access requests from personal mobility assistant 111, compiles and translates the requests into appropriate requests for the directory system resident in office productivity service 106 using end-to-end Messaging Infrastructure 101. It also takes data from the directory service resident in office productivity service 106, compiles, translates and organizes it for personal mobility assistant 111 using user interface 228. The messages can travel through any of the appropriate Interfaces in network gateway 123. In one embodiment, appropriate directory information is cached in information storage 242 to optimize the access performance.

Calendar orchestration 222, takes calendar access and update requests from personal mobility assistant 111, and compiles and translates the requests into appropriate requests for the calendar system resident in office productivity service 106 using end-to-end Messaging Infrastructure 101. It also takes data from the calendar service resident in office productivity service 106, and compiles, translates and organizes it for personal mobility assistant 111 using user interface 228. The messages can travel through any of the appropriate Interfaces in network gateway 123. In one embodiment, user specific calendar information is cached in information storage 242 to optimize access performance.

Location management 223 tracks the locations of users. FIG. 3a illustrates location areas and handover boundaries according to one embodiment of the present invention. All access points belonging to the same subnet are organized into a location area. In this illustration, all access points are organized into two location areas, location area 1 and location area 2. Within location area 1 there are seven access points, AP11 to AP17. AP13 is in the interior of location area 1 and is known as an Interior access point while AP11, AP12, AP14, AP15, AP16 and AP17 are at the edge of location area 1 and are thus known as Edge access points. Location area 3 is used to identify a cellular network next to location area 1. The Edge access points mark the boundary between location areas and is used for Inter-Subnet and Inter-Network handovers. As a user is authenticated by key handling 211, the location of the user is relayed to location management 223. User location information is represented by a number of information elements such as location area, IP address of the access point and the location area of the cellular network. User location information is stored in information storage 242. Location management 223 also works with directory orchestration 220 to incorporate location information on the directory information presented to users accessing the directory.

Presence management 224, captures a user's current presence activity information (such as active on a call). If the office productivity service 106 has presence service support, Presence management 224 receives presence information from office productivity service 106. It also takes user presence update requests from personal mobility assistant 111. If office productivity service 106 supports a presence service, it sends all presence updates to office productivity service 106. User presence information is stored in information storage 242. Presence management 224 also works with directory orchestration 220 to incorporate presence information on the directory information presented to users accessing the directory.

Handover management 225 controls the handover activity when an active call is handed over from one subnet to another subnet or when an active call is handed over to a different network (for example, from a circuit switch 105 to a cellular network 104). An Autonomous and Predictive handover method includes trigger, preparation, and handover steps. Handover is triggered when handover management 225 receives a handover request from QoS management 227 as a result of detecting unacceptable quality of service. It can also be triggered when a user carries an active call into an edge access point of a location area. Once a handover is triggered, handover management 225 prepares for handover by identifying at least one target location areas. In conjunction with personal mobility assistant 111 and call orchestration 220, at the appropriate time based on some predictive probability of when the user is about to cross the handover boundary, handover management 225 initiates call connections via identified target location areas. If the handover is determined to be between networks, handover management 225 looks up the network number to be connected from the user's preference information within information storage 242. A call connection is established from the appropriate interface from network gateway 123 to mobile station 110. Note that in one embodiment both existing and new connections terminate on the same dual mode mobile station 110. This also occurs when an existing connection and a new connection terminate on separate mobile stations 110, such as in the case of handing over a call from a single mode WiFi handset to a single mode cellular handset. As handover management 225 initiates a connection for the handover preparation, a timer is started to control when the existing handover preparation connection should be abandoned and when a new handover preparation connection should be established. After the handover preparation is initiated, mobile station 110 monitors the QoS of the existing connection, if the QoS threshold is crossed, it accepts the handover preparation connection and cuts over the media path. Once the new connection is established and stable, if both connections are available, a quality of service comparison is done between the new connection and the old connection and the inferior connection is dropped, thus completing the handover. If the handover is between radio subnets and mobile station 110 has only one wireless interface 241, call management 323 of personal mobility assistant 111 performs radio signal strength tests on both radio subnets and determines which radio subnet is to be used and a hard handover is executed between call management 323 of mobile station 110 and handover management 225.

Presence management 224 captures user current presence activity information such as active on a call. If the office productivity service 106 has presence service support, presence management 224 may receive presence information from office productivity service 106. It also takes user presence update requests from personal mobility assistant 111. If office productivity service 106 supports presence service, it sends all presence updates to office productivity service 106. User presence information is stored in information storage 242. Presence management 224 also works with directory orchestration 220 to incorporate presence information on the directory information presented to users accessing the directory.

Account and operations and maintenance (OAM) management 226, manages user account information and mobility orchestration server network configuration, operation and maintenance activities. User account information contains user preference information and operating data specific to the user such as the personal mobility assistant 111 identification, public keys and certificate data associated with the personal mobility assistant 111, mobile station 110 capabilities, the associated home mobility orchestration server 120 identification, cellular number, office business number, presence data, and personal calendar information. The OAM data and associated operations are also maintained. In one embodiment, Account and OAM management 226 is implemented with a web browser to facilitate easy access by end users to update the user account information and to facilitate easy access by operators to effect OAM management of the mobility orchestration server 120 network.

Quality of Service management 227, monitors and maintains the quality of service for all connections. Quality of Service management 227 collects information on jitter, delay, Mean Opinion Score, and radio signal strength to gauge the Quality of Service on the connections. Based on quality of service thresholds associated with different types of connections, Quality of Service management 227 initiates handover preparation activities with personal mobility assistant 110 and triggers handover requests using handover management 225. Quality of Service management 227 also renegotiates connection speed with Quality of Service management 325 of personal mobility assistant 110 when the handover results with a connection having a different bandwidth than the existing connection.

User interface 228 manages presentation information from other components of Service management 122, information security 121, and network gateway 122 designated for the user in conjunction with user interface 321 of Service management 221 of personal mobility assistant 111 of mobile station 110.

Programmable computer platform 240 is chosen to provide highly reliable operation and flexible scalability and are available from vendors such as SUN, HP, Motorola, and Intel. Programmable computer platform 240 also includes an information storage medium 241 for holding the data required by components information security 121, Service management 122, and network gateway 123.

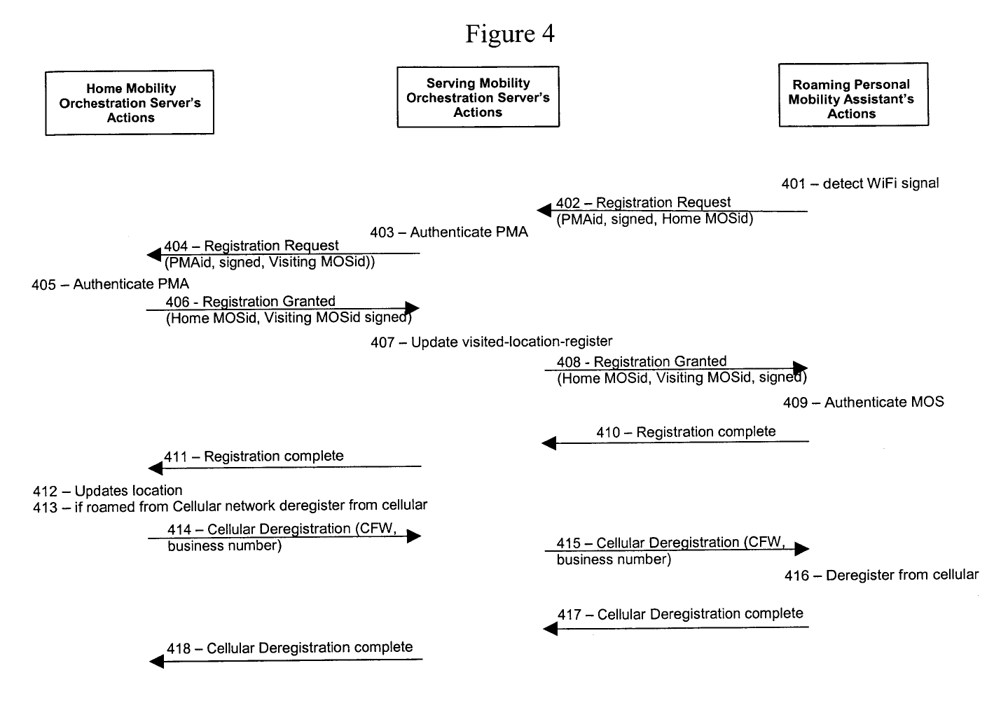

FIG. 4 illustrates a signaling sequence chart and flow chart for an exemplary roaming process, according to one embodiment of the present invention. Home mobility orchestration server is a mobility orchestration server 120 with which the user configures and certifies a mobile station 110. Mobility orchestration server 120 services the user's mobile station 110. When the roaming user's personal mobility assistant 111 detects the presence of WiFi radio signal, it determines that the signal is strong enough to register and checks that the user's preference data ranks WiFi access a higher priority than cellular (401). Personal mobility assistant 111 retrieves the personal mobility assistant's identification address and the home mobility orchestration server's identification address, composes a registration request message, and signs it with the private key of the security certificate assigned to it by the home mobility orchestration server at the time the personal mobility assistant 111 was initialized and configured. In one embodiment, both mobility orchestration server and personal mobility assistant identification addresses-follow the structure of a Uniform Resource Identifier (URI). The message is addressed to the home mobility orchestration server 120.

The personal mobility assistant 111, in conjunction with WiFi wireless interface 241 of wireless client 113 acquires network access from the WiFi radio access point. In one embodiment, the serving mobility orchestration server 120 is configured as an authentication server for the WiFi radio access system. The serving mobility orchestration server 120 receives the Registration request (402), and attempts to authenticate the personal mobility assistant 111 (403), and determines that the personal mobility assistant 111 is from a different mobility orchestration server 120. It attaches its own identification address to the Registration request and forwards that to personal mobility assistant's 111 home mobility orchestration server 120. The home mobility orchestration server receives Registration request message 404, and authenticates the personal mobility assistant 111 (405). It retrieves the personal mobility assistant's identification address from the message, retrieves the associated public key from information storage 241, and decrypts the message. If the decryption succeeds, the personal mobility assistant is authenticated and access is granted.

A registration granted message 406 is constructed and signed with the home mobility orchestration server's private crypto key, and sent via the serving mobility orchestration server 120 to the personal mobility assistant 111. Visiting mobility orchestration server 120 (407), adds personal mobility assistant into its visitor location register and forwards the Registration Granted message to personal mobility assistant (408). Personal mobility assistant 111 authenticates the home mobility orchestration server 120 (409). It decrypts message 409 with the home mobility orchestration server's 120 public key received at the time the personal mobility assistant 111 was first configured. If the decryption succeeds, the home mobility orchestration server is authenticated. Messages 410 and 411 Registration Complete are used to notify the home mobility orchestration server 120 that the mutual authentication has completed successfully. Home orchestration server 120 updates the location information of the user (412). If the present registration is an update of an existing WiFi registration, the user has roamed from one WiFi-covered area to another WiFi-covered area. If the user does not have a WiFi registration prior to the present registration request, the user has roamed from a cellular network into a WiFi-covered area. The location management 223 of Service management 122 of home mobility orchestration server 120 de-registers the user from the Cellular network (413). It retrieves user's cellular deregistration process and default business number from information storage 242. In one embodiment, the cellular deregistration process is to Call Foward All Calls to the user's business number. A message 414 is constructed to instruct personal mobility assistant 111 to initiate a call-forward-all-calls feature request to the cellular network to forward all calls to the user's business number. The message is forwarded by the visiting mobility orchestration server 120 as message 415 to personal mobility assistant 111. Personal mobility assistant 111 initiates call-Forward-all-calls to the user's business number to the cellular network. Upon successful completion, a message 417 is sent by personal mobility assistant 111 to the serving mobility orchestration server 120 to complete the de-registration process. The mobility orchestration server 120 forwards message 417 as message 418 to the home mobility orchestration server 120 to complete the cellular deregistration process. If the roaming user does not have the support of a personal mobility assistant 111, provision is made in the mobility orchestration server 120 to authenticate the user employing traditional user-id and password challenge-response protocols. However, the user thus authenticated will not be treated as part of the fully authenticated and trusted community and will not have full access to all virtual mobility network 100 services.

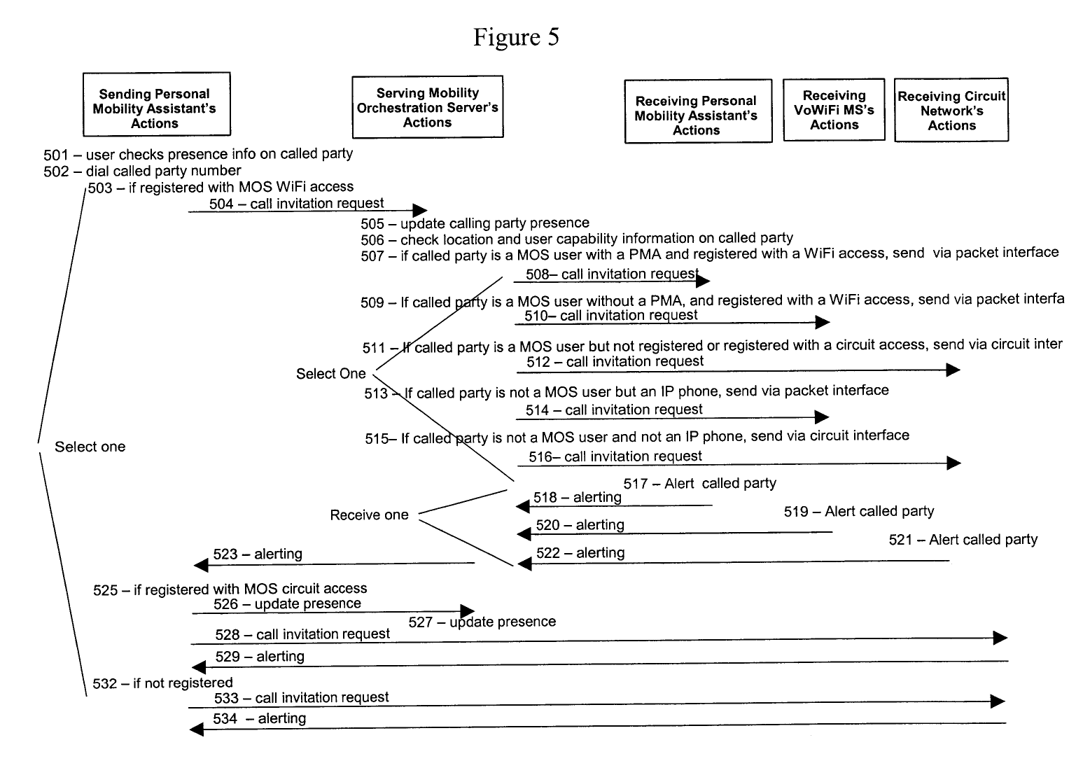

FIG. 5 illustrates a signaling sequence chart and flow chart for an exemplary outgoing call process according to one embodiment of the present invention. More particularly, FIG. 5 illustrates a mobility orchestration server 120 user (with personal mobility assistant 111 support) making an outgoing call to another virtual mobility network 100 user. The calling user using a mobile station 110 accesses the presence information on the enterprise directory to check if the called user is free to receive a call (501). Personal mobility assistant 111 in conjunction with Service management 122 of mobility orchestration server 120 and the directory service in Office Productivity Server 106 presents the presence information in the context of the enterprise directory to the user. The calling user selects the directory entry and initiates the call function on the mobile station 110 to initiates a call to the called user (502). Personal mobility assistant 111 then takes one of the three branches 503, 525, or 532 depending on its registration status.

Branch 503 is selected, if calling user's mobile station 110 is registered using mobility orchestration server 120 with a WiFi access account. A call request message 504 is sent to the serving mobility orchestration server 120. The service mobility orchestration server 120 updates the calling party's presence information reflecting whether the calling user is busy on a call (505). If the serving mobility orchestration server 120 is the same as the calling user's home mobility orchestration server 120, messages may be relayed to the home mobility orchestration server 120 to update the calling user's presence information. For simplicity, the rest of the description assumes the serving and home mobility orchestration servers are the same. Mobility orchestration server 120 checks the location and user capability of the called user from information storage 241 (506).

Depending on the user location and capability, one of the five branches 507, 509, 511, 513, and 515 is taken. Branch 507 is selected if the called user is: a mobility orchestration server 120 user, has a personal mobility assistant 111 who is registered for a WiFi access account. Call invitation message 508 is sent via packet network Interface 231 to personal mobility assistant 111 for the called user. Branch 509 is selected if the called user is a mobility orchestration server 120, but does not use personal mobility assistant 111, and he is registered on a WiFi network. Call invitation message 510 is sent via packet network Interface 231 to the WiFi mobile station for the called user. Branch 511 is selected if the called user is a mobility orchestration server 120 user but has circuit network access such as a cellular network or a fixed carrier Public Switch Telephone Network. Service Manager 122 of mobility orchestration server 120, retrieves the called user's preferred circuit network number, for example a cellular number or a residential telephone number. A call invitation message 512 is sent via circuit network Interface 232 to the circuit network for the called user.

Branch 513 is selected if the called user is not a mobility orchestration server 120 user, but it is determined that the called user is an IP phone user. The called user is an IP phone user, if the calling user dialed an IP address or the called user's telephone number has an IP address mapping in the ENUM database. A call invitation message 514 is sent via packet network Interface 232 to the IP phone for the called user. Branch 515 is selected if the called user is not a mobility orchestration server 120 user and it is determined that the called user is not an IP phone user. A call invitation request message 516 is sent via circuit network Interface 232 for the called user. Depending on which branch was taken, one of three alerting messages 518, 520, and 522 is received by mobility orchestration server 120 from the called user's system. Upon receipt of one of the alerting messages, mobility orchestration server 120 relays the alerting message to personal mobility assistant 111 and thus completes branch 503.

Branch 525 is selected, if the calling user is registered with mobility orchestration server 120 through a circuit network access. This may be the case when the calling user is connected to a cellular network 104 but has registered via a data connection through the cellular network 104 to the mobility orchestration server 120. The calling user's personal mobility assistant 111 sends a presence update message 526 to mobility orchestration server 120 to indicate that it is busy on a call. Personal mobility assistant 111 then sends a call invitation request message 528 to the circuit network 232 for the called user. Upon receipt of message 526, mobility orchestration server 120 updates the calling user's presence information (527). alerting message 529 from the called user completes branch 525.

Branch 532 is selected, if the calling user is not registered with any mobility orchestration server 120. This may be the case if the calling user is connected to a cellular network 104 but has not data connection capability. The calling user's mobile station 110 sends a call invitation request message 533 to the circuit network 232 for the called user. alerting message 534 from the called user completes branch 532.

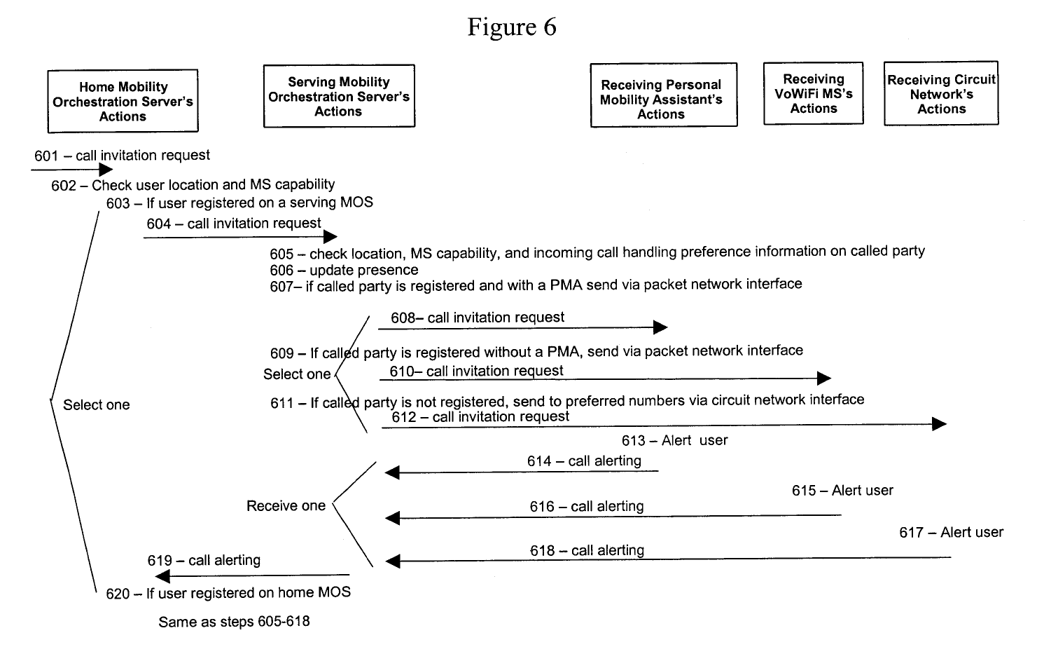

FIG. 6 illustrates a signaling sequence chart and flow chart for an exemplary incoming call process according to one embodiment of the present invention. This method starts when a call invitation request message 601 is received at the user's home mobility orchestration server 120. Home mobility orchestration server 120 checks the location and user capability of the called user from information storage 241 (602). Depending on the user's location, one of branch 603 and 619 is taken.

Branch 603 is selected if the called user is registered with a serving mobility orchestration server 120 as a visitor. Message 604 call invitation request is sent by home mobility orchestration server 120 to mobility orchestration server 120 for the called user. Serving mobility orchestration server 120 checks the current location, user mobile station 110 capability, call handling preference, and presence information on called user from the visitor location register of information storage 241 (605). The called user's presence information is updated to reflect busy on a call (606). Depending on the called user's location and mobile station's 110 capability, one of the three branches 607, 609, and 611 is taken.

Branch 607 is selected, if the called user has personal mobility assistant 111 support and is registered. Call invitation request message 608 is sent via packet network Interface 231 to the called user. Branch 609 is selected if the called user has no personal mobility assistant 111 support but is registered. Call invitation request message 610 is sent via packet network Interface 231 to the called user. Branch 611 is selected, if the called user is not registered. The called user's preferred connecting circuit number, for example a cellular number, is retrieved from the user's preference data from information storage 241. A call invitation request message 612 is sent via circuit network Interface 232 to the called user. Depending on which of the branches 607, 609, and 611 is selected, one of the three call alerting messages 614, 166, and 618 is received by the mobility orchestration server 120. Upon receipt of one of the call alerting messages, serving mobility orchestration server 120 relays the call alerting message to home mobility orchestration server 120 with message 619.

Branch 621 is selected if the called user is registered with the home mobility orchestration server 120. In this situation, since there is no serving mobility orchestration server 120 between the called user and the home mobility orchestration server 120, are executed with home mobility orchestration server 120.

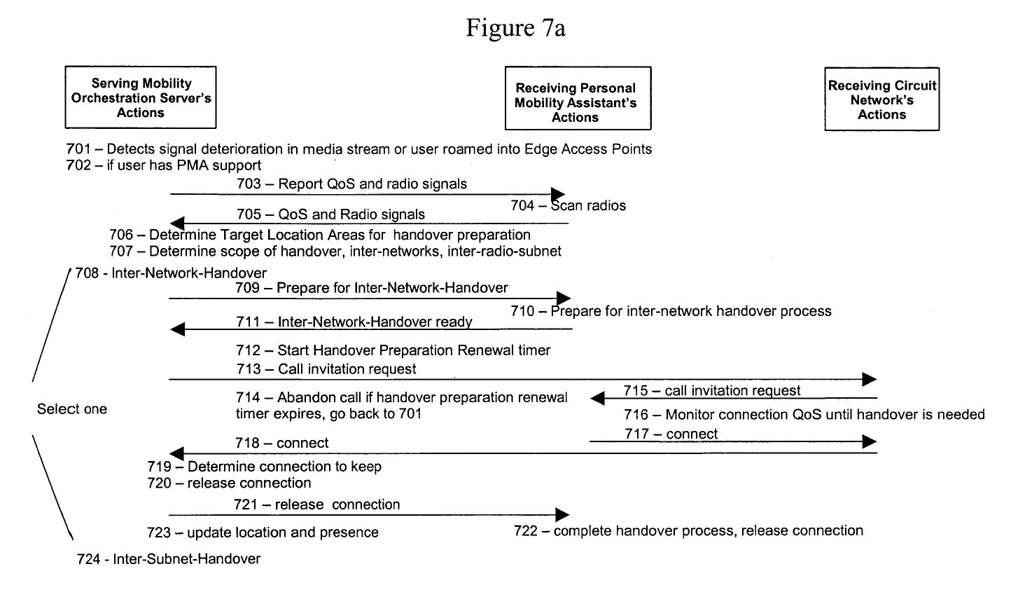

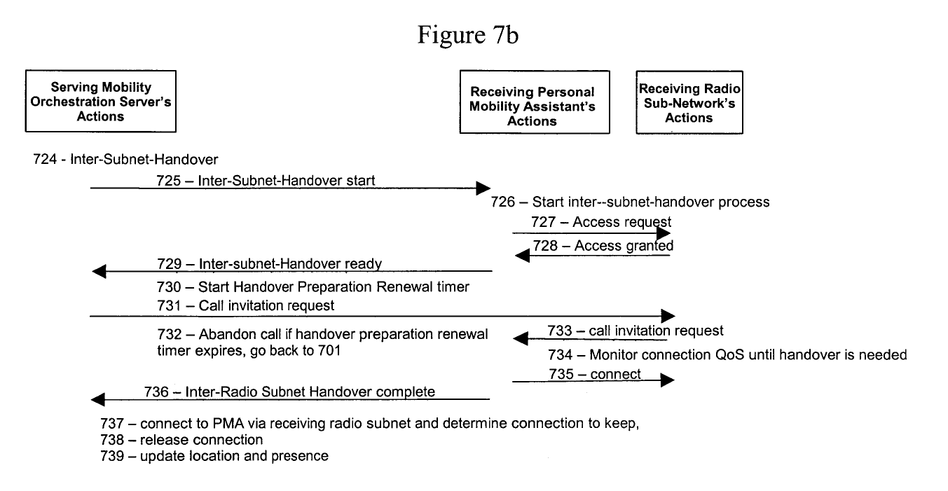

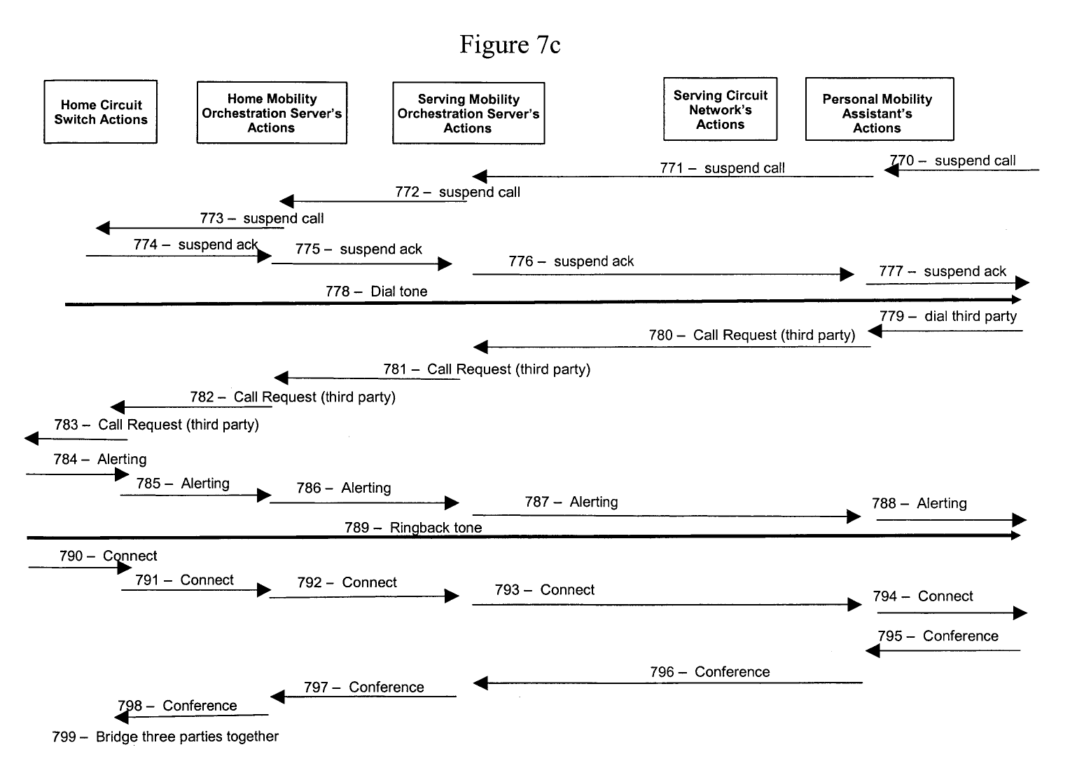

FIGS. 7a and 7b illustrate signaling sequence charts and flow charts for an exemplary handover to a cellular network and a handover between subnets processes, according to one embodiment of the present invention. The two accesses may be attached to two different networks or to two different radio subnets. FIG. 7a describes a process to handover a call between networks, while FIG. 7b outlines a process to handover a call between two subnets. To determine if a handover is needed for an active call, jitter, delay, mean opinion score, and the radio signal strength of the active media connection are monitored continuously by both Quality of Service management 227 of mobility orchestration server 120 and the Quality of Service management 325 of personal mobility assistant 110. The locations of a user are monitored by location management 223 to determine if any user has entered an Edge access point. A handover preparation is triggered if a user has entered an Edge access point.

Quality of Service management 227 of mobility orchestration server 120 detects deterioration in the media stream (701) and location management 223 detects that a user entered an Edge access point (702). Mobility orchestration server 120 coordinates the quality of service measurements with mobile station 110. Report Quality of Service and Radio Signal message 703 is sent to mobile station 110. Mobile station 110 measures surrounding radio signal profiles and captures current quality of service data (704) and sends them to mobility orchestration server in message 705. Message 705 can also be sent by personal mobility assistant 111 autonomously without first prompted by mobility orchestration server, when quality of service measurement of the media channel has degraded beyond a certain threshold. Mobility orchestration server 120 determines the scope of the handover with the measured quality of service data (706) and location information of the user (707). Depending on the scope of the handover, one of branches 708 and 724 is taken.

Branch 708 is selected, if the handover is to be taken place between two networks. Mobility orchestration server 120 instructs personal mobility assistant 111 to get ready for an inter-network handover with message 709. Personal mobility assistant 111 registers for service on the receiving circuit network if it has not yet registered or has previously de-registered (710). If call-forward-all-calls feature was activated on the receiving circuit network, it de-activates it. When the preparation is complete, personal mobility assistant 111 sends message 711 to mobility orchestration server 120. Handover management 225, starts handover preparation renewal timer (712) and sends call invitation request message 713 to establish a connection to mobile station 110 via the receiving circuit network. The handover preparation renewal timer is used to monitor total time elapsed since the call invitation request message 712 was sent. The timer is set shorter than the Call Forward No Answer timer of the target serving network. If the handover preparation renewal timer expires before personal mobility assistant 111 accepts and connects to the new connection (714), handover management 223 releases the new connection, restarts the timer and goes back to determine if a handover is still needed (701).

In one embodiment, a session initiation protocol server environment is used to manage calls in mobility orchestration server 120. The call invitation is extended using the same call identification address of the existing two-party call to modify the call to a three-party call with two connections to mobile station 110. The receiving circuit network, upon receipt of call invitation message 713, sends message 715 to personal mobility assistant 111 of mobile station 110 to establish the connection. Personal mobility assistant 111, (based on calling number), knows the incoming call is from mobility orchestration server 120 to prepare for the handover and does not connect to the call Instead it monitors the QoS of the existing connection to determine if it needs to connect to the new connection to accept the handover or not (716). When needed, personal mobility assistant 111 sends connect message 717 to the receiving circuit network. Upon receipt of message 717, receiving circuit network relays the connect message to mobility orchestration server 120 with message 718.

Mobility orchestration server 120 selects one of the two connections to mobile station 110 to continue the active call (719). The selection is done based on the relative quality of the connections. The quality of service metrics of both connections are taken and compared over a predetermined period of time to ensure that a stable and accurate decision is made on which of the two connections is better. Mobility orchestration server 120 releases the connection with mobile station 110 (720). A release connection message 721 is sent to personal mobility assistant 111 to release the connection. Personal mobility assistant 111 releases the connection (722). Mobility orchestration server 120 updates the user's location and presence information to reflect the new connection established with mobile station 110 (723).

Branch 724 in FIG. 7b is selected if the handover is to occur between two radio subnets. Message 725 is sent to personal mobility assistant 111 to start the inter-subnet handover process. The message may contain the address of a receiving access point from the target location area that the personal mobility assistant 111 is to handover the active call to. This target may be selected based on the quality of service and radio signal strength report from message 705 collected by personal mobility assistant 111, and the nearest access point from the target location area. Personal mobility assistant 111 prepares for inter-radio-subnets handover (726). Message 727 is sent to the receiving radio subnet to request for service. Upon receipt of access granted message 728 from the receiving radio subnet, personal mobility assistant 111 sends confirmation message 729 to mobility orchestration server 120 that the handover preparation has completed. Upon receipt of message 729, handover management 225, starts handover preparation renewal timer (730) and sends call invitation request message 731 to establish a connection to mobile station 110 via the receiving radio subnet. If the handover preparation renewal timer expires before personal mobility assistant 111 accepts and connects to the new connection, handover management 223 releases the new connection, restarts the timer (723) and determines if a handover is still needed (701).

The receiving radio subnet, upon receipt of call invitation message 731, sends message 733 to personal mobility assistant 111 of mobile station 110 to establish the connection. Personal mobility assistant 111, based on the call identification address, knows that the incoming call is from mobility orchestration server 120 which is preparing for inter radio subnet handover (734). It does not connect to the call, and instead monitors the QoS of the existing connection to determine if it needs to connect to the new connection to accept the handover. When needed, personal mobility assistant 111 sends connect message 735 to the receiving radio subnet. It also sends a inter-subnet-handover complete message 736 to mobility orchestration server 120. Mobility orchestration server 120 selects one of the two connections to mobile station 110 to continue the active call (737). The selection is done based on the relative qualities of the connections. The quality of service metrics of both connections are taken and compared over a predetermined period of time to ensure that a stable and accurate decision can be made on which of the two connections is better. Mobility orchestration server 120 releases the connection with mobile station 110 (738). Mobility orchestration server 120 updates the user's location and presence information to reflect the new connection established with mobile station 110 (739).

In another embodiment, when a user is holding an active call using a desktop phone connected with circuit switch 105 (which is controlled by the mobility orchestration server 120 via interface 125), the user can invoke inter-network handover via personal mobility assistant 111 of mobile station 110 to instruct mobility orchestration server 120 to handover the active call to the mobile station 110. Upon receipt of the handover request from the user, branch 724 is entered to prepare the call handover from the desk phone to the user's mobile station 110. In this scenario, branch 724 is executed as in the inter-subnet handover process outlined above. However, instead of monitoring QoS of existing connection to determine if a handover is needed, personal mobility assistant 111 determines if the incoming call is a desk phone handover call from mobility orchestration server 120. This is done by determining that it has requested a handover and it does not have any existing call. In this embodiment, it simply connects to the incoming call and completes the handover process.

FIG. 7c illustrates a signaling sequence chart and flow chart for an exemplary Three way conference service on a user's home circuit switch system according to one embodiment of the present invention. In this illustration the feature to access remotely is three way conference resided in the enterprise Private Branch eXchange. The remote network is a cellular network. Other features can also be accessed using a similar process from other remote networks. The user initiates a sequence of feature operations for three way conference starting with suspending the active call or more generally referred to as putting the call on hold (770). Upon receipt of the call suspension request by mobile station 110, personal mobility assistant 111 intercepts the request and relays the request to home mobility orchestration server 120. This is done via message 771 and 772 through serving mobility orchestration server 120 using end-to-end messaging infrastructure 101 and bypassing the serving circuit network 103. The serving circuit network 103 is a cellular network 104. Home mobility orchestration server 120 sends a suspend request message 773 to user's home circuit switch 105 through circuit switch interface 233 of network gateway 123. Home circuit switch 105 executes system logic to suspend the active call, putting it on hold.

After the call has been suspended, suspend acknowledgement message 774 is sent back to home mobility orchestration server 120 via circuit switch interface 233. Home orchestration server 120 replays the suspend acknowledgement message to personal mobility assistant 111 via message 775 and 776 using end-to-end message infrastructure 101. Personal mobility assistant 111 presents the suspend acknowledgement to the user (777). Home circuit switch 105, while sending suspend acknowledgement message 774 to home mobility orchestration server 120, also applies dial tone to the media channel to signify to the user that he can start dialing the third party.

Upon hearing the dial tone and receipt of the call suspension acknowledgement, the user proceeds to dial the third party connection address (779). Personal mobility assistant 111 intercepts the dial digits, composes a call request message 780 and sends it to serving mobility orchestration server 120 using end-to-end message infrastructure 101, bypassing the serving circuit network 103. Serving orchestration server 120 relays the call request message to home mobility orchestration server 120 with message 781. Upon receipt of message 781, home mobility orchestration server 120 relays the call request message to home circuit switch 105 with message 782. Home circuit switch 105 then initiates a call to the third party with message 783.

Upon receipt of alerting message 784 from the far end switch serving the third party, home circuit switch 105 relays the alerting message to home mobility orchestration server 120 via circuit switch interface 233 with message 785. Upon receipt of message 785, home mobility orchestration server 120 relays the alerting message to personal mobility assistant 111 via serving mobility orchestration server 120 using end-to-end message infrastructure 101 with messages 792 and 793. Personal mobility assistant 111 presents the alerting information to the user that is most appropriate for mobile station 110 (788). Upon receipt of alerting message 784 by home circuit switch 105, ring back tone is applied by the far end Switch of the third party to the media channel connecting to the user. When the third party answers the call, connect message is sent from the far end switch to the user via home circuit switch 105, home mobility orchestration server 120, serving mobility orchestration server 120 with messages 791, 792 and 793. Personal mobility assistant 111, in conjunction with mobile station management 112, presents the third party connected status and presents the option to bridge all parties together to the user. User selects to bridge the conference (795). The message is relayed similarly to previous messages by personal mobility assistant 110 to home circuit switch 105 with messages 796, 797 and 798. Upon receipt of message 798, home circuit switch applies system logic to bridge the three parties together into a three way conference (799).

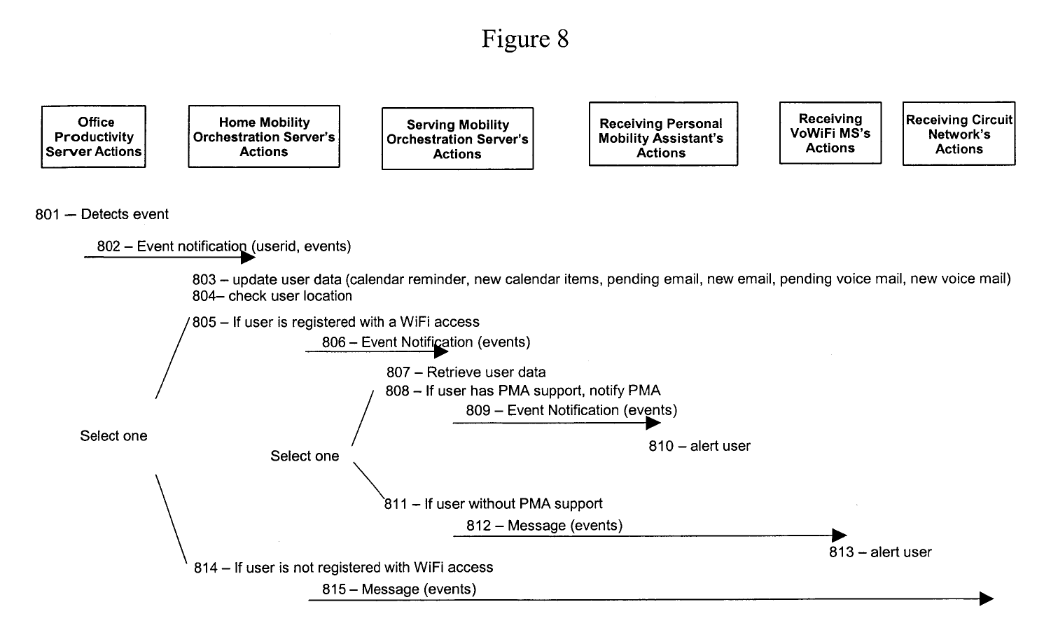

FIG. 8 illustrates a signaling sequence chart and flow chart for an exemplary event notification process according to one embodiment of the present invention. office productivity service 106 detects the occurrence of an event (801). The event may be that: a new email arrived at the user's email inbox, a new voice mail arrived at the user's voice mail box, a calendar appointment reminder, someone booked a new appointment on the user's calendar, or other events which need to be communicated to the user. office productivity service 106 using end-to-end message infrastructure 101, sends an event notification message 802 to home mobility orchestration server 120 for the user, indicating what the event was that triggered the notification, with specific data associated with the event. For example, if the event was a new voice mail in the user's voice mail box, the message may carry voice mail as the event and the number of unread voice mails in the user's voice mail box. Home mobility orchestration server 120 updates user data in information storage 241 based on the data associated with the event (803). For example, for voice mail event notification, the number of unread voice mails may be stored as part of the user data in information storage 241. Home mobility orchestration server 120 checks the user location information from information storage 241 (804). Depending on whether the user is registered with mobility orchestration server 129, either branch 805 or branch 813 is taken.

Branch 805 is selected if the user is registered. In one embodiment, the user is registered with a serving mobility orchestration server 120. Home mobility orchestration server 120 relays the event notification message to serving mobility orchestration server 120 with message 806. Upon receipt of message 806, serving mobility orchestration server 120 retrieves user profile information from visitor location register in information storage 241 (807). If the user's mobile station 110 has personal mobility assistant 111 support, branch 808 is selected and message 809 is sent to deliver the event notification to personal mobility assistant 111 by serving mobility orchestration server 120 using end-to-end message infrastructure 101. Personal mobility assistant 111 in conjunction with mobile station management 112 alert the user about the event (810). If user does not have personal mobility assistant 111 support, branch 811 is selected and message 812 is sent to mobile station 110. Mobile station 110 alerts the user about the event (813).

Branch 813 is selected if user is not register with any WiFi access network. A message 815 is sent to the user via the circuit network 104 access number. The circuit network 104 is a cellular network 105.

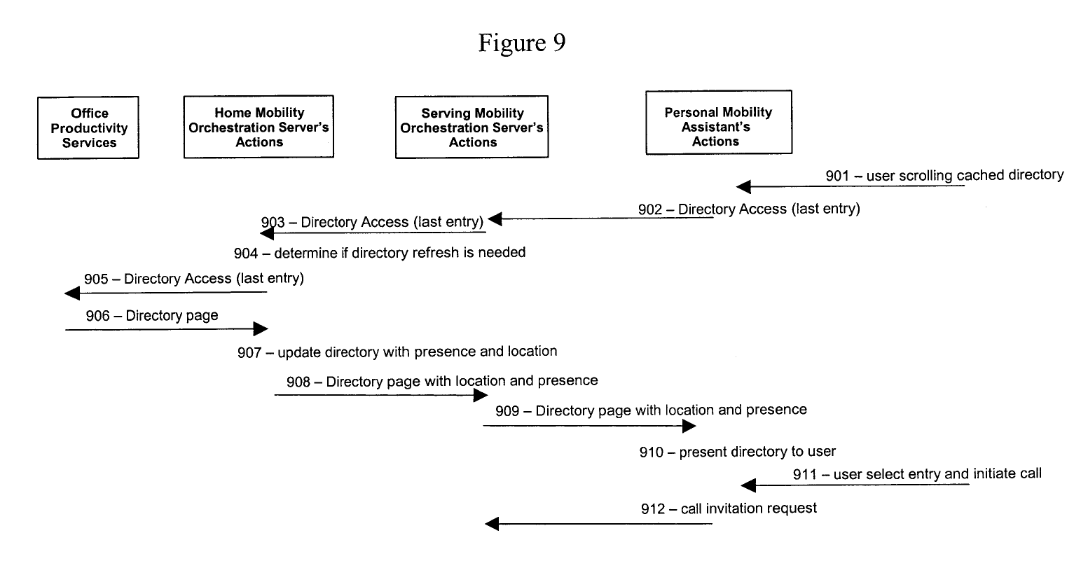

FIG. 9 illustrates a signaling sequence chart and flow chart for an exemplary remote dialing process, according to one embodiment of the present invention. A user selects directory service with user interface 321 of personal mobility assistant 111 (901). Personal mobility assistant then sends directory access message 902 with the last entry marker to serving mobility orchestration server 120. Serving mobility orchestration server 120 relays the directory access message to home mobility orchestration server via message 903. Home mobility orchestration server determines if local cache refresh is needed (904) and a directory access message 905 is sent to office productivity services 106 for further process. Upon receipt of the request, the directory service of office productivity service 106 retrieves and composes directory page information and forward that to home mobility orchestration server 120 in message 906. Directory orchestration 221 of home mobility orchestration server 120 updates the cached presence and location database with the directory information (907). User interface 228 of home mobility orchestration server composes the directory page with location and presence information and forwards that to user interface 321 of personal mobility assistant 111 via serving mobility orchestration server with messages 908 and 909. Personal mobility assistant 111 in conjunction with the mobile station management 112 presents the directory information to the user (910). A user can select an entry from the directory presented to initiate a call (911). Upon receipt of the request, personal mobility assistant 111 initiates a call invitation request message 912 to place the call.

A method and system for a virtual mobile network have been disclosed. Although the present methods and systems have been described with respect to specific examples and subsystems, it will be apparent to those of ordinary skill in the art that it is not limited to these specific examples or subsystems but extends to other embodiments as well.

What is claimed is:

1. A system, comprising:
one or more networks;
a plurality of mobile stations in communication with the one or more network; and
a mobile management server in communication with the one or more networks, comprising a service manager, an information security module and call management gateway.

2. The system of claim 1, wherein each mobile station of the plurality of mobile stations, comprise:
a mobile station manager that controls mobile station resources and enables communication with a user;
a personal mobility assistant that manages mobile station services and maintains security of information received and sent by a mobile station.

3. The system of claim 2, wherein the mobile station manager comprises:
a resource manager that controls a plurality of resource elements, wherein the plurality of resource elements include a display, a speaker, a microphone, a radio, and a electronic memory; and
a user interface capable of communicating to the user and allow the user to control the resource elements managed by the resource manager.

4. The system of claim 2, wherein the personal mobility assistant comprises:
a key handler that generates, stores and manipulates secure keys;
a media handler that generates, stores and manipulates one or more media streams; and
a message hander that manipulates messages, including encryption, and decryption of the messages; and
a personal mobility user interface capable of communicating with the mobility management server to control the user interface.

5. The system of claim 2, wherein the personal mobility assistant further comprises:
a user information storage that stores user specific information;
a call manager that allows the mobility orchestration server manipulate one or more call sessions on the plurality of mobile stations;
a personal mobility assistant resource manager that allows the mobility management server to control the plurality of resource elements; and
a quality of service (QOS) manager that allows the mobility management server to access and manipulate the QOS of connections terminated on a mobile station of the plurality of mobile stations.

6. The system of claim 2, wherein the mobile management server further comprises:
a service manager that performs a plurality of services, the plurality of services including location management, handover control, collaboration with a circuit switch PBX, collaboration with office productivity services, user account management and QOS management;
a network gateway that controls and manages network interconnections for communication with the one or more networks;
an information security module that generates, distributes and manages secure keys; and
an information storage that stores user profile information and user location data elements.

7. The system of claim 6, wherein the service manager comprises:
a call manager that coordinates, converges and manages voice calls from a plurality of nodes, the plurality of nodes including the circuit switch PBX, devices on a cellular network, and VoIP devices generating calls, data calls from productivity services and public directory services;
a directory manager that coordinates and manages directory services, the directory services including a corporate directory from an office productivity service, a cellular user directory, and a public carrier directory service;
a calendar manager that coordinates and manages calendar services, the calendar services including a corporate event directory, a corporate shared calendar, and a public calendar;
a location manager that collects, interprets and manages locations of the plurality of mobile stations;
a presence manager that collects and manages user presence information, the user presence information including busy on a voice call in the cellular network, engaged in a multimedia conference, or do not want to be disturbed;
a handover manager that manages handover trigger information, the handover trigger information including device signaling strengths, system load balancing data, and user's path of travel;
an accounting and OAM module that collects and manages usage, operational and administration data;
a QOS manager that collects and maintains quality of service data on connections with the plurality of mobile stations; and
a user interface that allows coordination with the plurality of mobile stations.

8. The system of claim 6, wherein the information security module further comprises:
a key handler that generates, stores and manipulates secure keys and certifies and authenticates the plurality of mobile stations;
a media handler that generates, stores and manipulates one or more media streams; and
a message hander that manipulates messages, including encryption, and decryption of the messages.
